(19) United States
(12) Patent Application Publication
(10) Pub. No.: US 2008/0053337 A1
(43) Pub. Date: Mar. 6, 2008

(54) Precipitated calcium carbonate from kraft pulp lime mud for use in filled and coated paper

(76) Inventors: Joseph Andrew Sohara, Bethlehem, PA (US); Steven Andrew Ciccarelli, Pen Argyl, PA (US)

Correspondence Address: Leon Nigohosian, Jr., 1 Highland Avenue, Bethlehem, PA, 18017, US

(21) Appl. No.: 11/514,649

(22) Filed: Sep. 1, 2006

(51) Int. Cl. C09C 1/02

(52) U.S. Cl. 106/464

(57) ABSTRACT

A process produces PCC from lime mud generated in the kraft pulping process. The process includes providing an aqueous suspension of lime mud, neutralizing the lime mud suspension, separating grit particles from the lime mud suspension, dewatering the lime mud suspension to produce dewatered lime mud solids, washing the dewatered lime mud solids to produce washed lime mud solids, and milling the washed lime mud solids to produce a PCC suitable for use as a filler and/or coating pigment for paper and paperboard.

The invention relates to mineral products produced from industrial process by-products, particularly to calcium-based mineral products produced from industrial process by-products.

The main component in paper and paperboard is a cellulosic pulp fiber that is produced from wood or other plant sources by a variety of mechanical and/or chemical pulping processes. The predominant chemical pulping process used in the paper industry is the alkaline “kraft” process, which uses sodium hydroxide (caustic soda) and sodium sulfide in a “digestion” process step to extract and separate non-cellulosic materials from the cellulosic pulp fibers in wood. In order to maximize the operational and economic efficiency of the kraft pulping process, chemicals are recovered and reused as much as possible.

All kraft pulping operations employ a lime kiln as part of the chemical recovery process. The function of the lime kiln is to produce lime (CaO) that is combined (slaked) with water to produce milk-of-lime (Ca(OH)₂). The milk-of-lime is then combined with “green liquor” in a process called causticization. The green liquor originates in another part of the kraft process that occurs between pulping and causticization.

The main chemical constituent of green liquor is sodium carbonate (Na₂CO₃), and the reaction of milk-of-lime with sodium carbonate produces caustic soda (NaOH) and calcium carbonate (CaCO₃) via the following process steps:

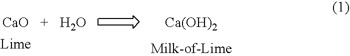

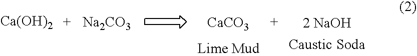

### Caustic soda is the major chemical component of the “white liquor” stream that is recycled for use in the digestion process step.

The calcium carbonate (CaCO₃) that is produced in process step (2) is called “lime mud”. In the kraft pulping process, step (2) is carried out under conditions that cause the lime mud to precipitate as relatively large particles that can be quickly and easily separated from the white liquor stream. After washing and filtration, the lime mud is recycled back to the lime kiln where it is calcined at temperatures of around 1000 degrees Celsius to regenerate lime (CaO) for reaction with green liquor, as described by the following process step:

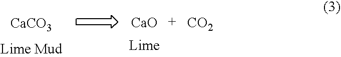

Lime mud cannot be recycled indefinitely without losses or discharges. Gradual degradation of lime mud particles occurs over time, and this can lead to inefficiencies in the calcination step described by process step (3). To maintain efficiency, it is necessary to purchase and introduce fresh lime (CaO) into the cycle on an ongoing basis.

In addition, paper mill lime kilns incur both planned and unplanned outages. During lime kiln outages, pulping must continue, and purchased lime is used for the causticization step. During lime kiln outages, any lime mud that is produced from process step (2) must be discharged, usually to a landfill, a necessary but not particularly environmentally friendly solution.

Precipitated calcium carbonate (PCC) is a preferred filler and/or coating pigment used in various grades of paper and paperboard because of its inherently superior whiteness and brightness compared to other mineral pigments. Another factor that has driven the adoption of PCC as a preferred paper and paperboard filler and/or coating pigment at paper mills (including, but not limited to, paper mills that produce pulp on-site using the kraft pulping process) is the availability of gaseous carbon dioxide (CO₂) at such mills. This availability has led to the proliferation of what has come to be known as “satellite PCC plants”, where a host paper mill provides CO₂ to a PCC production facility located on or near the paper mill site, which then uses the CO₂ as a raw material for the production of PCC. Lime (CaO), which is the other major raw material used in the production of PCC at the satellite plants is usually purchased and stored on-site.

Although lime mud is also calcium carbonate, unlike PCC, lime mud is unsuitable for use as a filler and/or coating pigment for paper and paperboard. This is because (1) lime mud particles are generally much larger than PCC used in paper and paperboard filling and/or coating applications, (2) the impurities present in the lime mud will give the material an off-white, gray or possibly a greenish coloration and (3) lime mud usually contains a high concentration of hard, abrasive particles referred to as grit.

Therefore, if lime mud with improved quality can be generated from the kraft pulping process to make it useful as a filler and/or coating pigment for paper and paperboard, then the amount of lime mud that is discharged to landfills can be reduced. Additionally, such solution would also improve the total utilization of lime purchased by both the host paper mill and the satellite PCC plant by transferring the maximum amount of useable filler and/or coating pigment to the papermaking and/or paper coating operation.

### SUMMARY

According to some embodiments, a process for producing PCC from lime mud generated in the kraft pulping process and use of said PCC as a filler and coating pigment for paper and paperboard is disclosed herein. PCC is produced from lime mud generated in the kraft pulping process by providing an aqueous suspension of lime mud, neutralizing the lime mud suspension with a nonmetal oxide, separating large lime mud particles and/or grit particles from the lime mud suspension, dewatering the lime mud suspension to produce dewatered lime mud solids, washing the dewatered lime mud solids to produce washed lime mud solids and milling the washed lime mud solids to produce a final PCC material.

The PCC produced from lime mud generated in kraft pulping process is suitable for use as a filler for paper and paperboard. In some embodiments, PCC produced from lime mud generated in the kraft pulping process is used as a coating pigment for paper and paperboard. In some embodiments, PCC produced from lime mud generated in the kraft pulping process is used as an additive in polymers such as, but not limited to, plastics, sealants and the like.

### BRIEF DESCRIPTION OF THE DRAWINGS

FIG. 1 is a schematic flow chart of a process for producing PCC in some embodiments;

FIG. 2 is a graph of TAPPI Brightness versus percent filler for a paper filled with a commercially available PCC compared to a PCC according to an embodiment of the invention; and

FIG. 3 is a graph of Sheet Gloss for a paper coated with a commercially available PCC compared to a PCC according to an embodiment of the invention.

### DETAILED DESCRIPTION

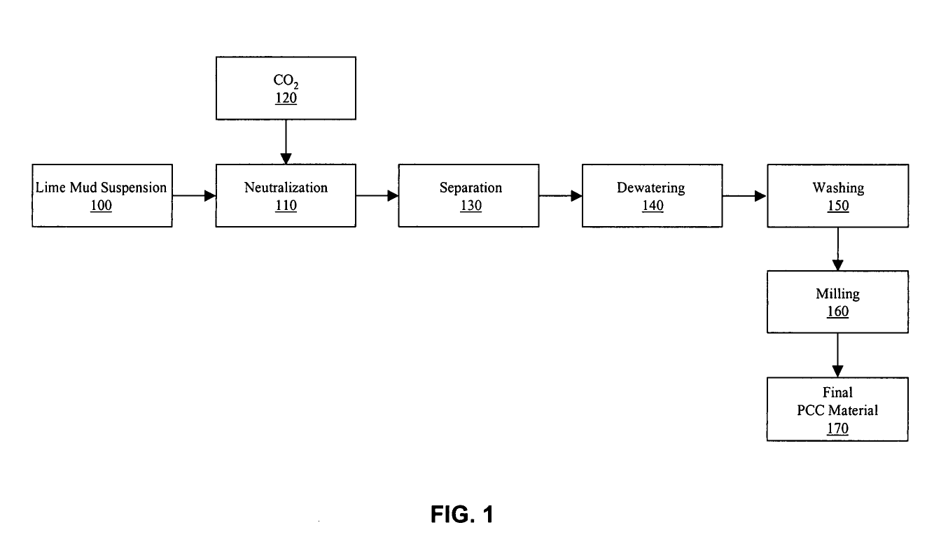

An exemplary process according to an embodiment is shown in FIG. 1 and generally comprises a step 100 of providing an aqueous suspension of lime mud, a step 110 of neutralizing the lime mud suspension by adding carbon dioxide 120 to the lime mud suspension, a step 130 of separating large lime mud particles and/or grit particles from the neutralized lime mud suspension, a step 140 of dewatering the separated lime mud suspension to produce dewatered lime mud solids, a step 150 of washing the dewatered lime mud solids to remove water-soluble impurities and a step 160 of milling the washed lime mud solids to produce a final PCC material 170.

The step 110 of neutralizing the lime mud suspension can be achieved by adding one or more nonmetal oxides. The nonmetal oxides react with water to produce sufficient acidity to react with and neutralize the excess alkalinity of the lime mud suspension due to the presence of alkaline compounds including, but not limited to, sodium hydroxide (NaOH), calcium hydroxide (Ca(OH)₂) and the like. According to some embodiments, the one or more nonmetal oxides should be added in sufficient quantity so that the reaction produces a lime mud suspension pH of about 9.5 or less. In other embodiments, a nonmetal oxide is introduced into the lime mud suspension in an amount sufficient to produce a lime mud suspension pH of from about 7.0 to about 9.5. The amount of nonmetal oxide required for neutralization can be determined by measuring the lime mud suspension pH during the neutralization process step.

Exemplary nonmetal oxides that can be used to neutralize the lime mud suspension include, but are not limited to carbon dioxide (CO₂), sulfur dioxide (SO₂), sulfur trioxide (SO₃) and mixtures thereof. The nonmetal oxides may be introduced to the lime mud suspension as a solid, liquid or gas. Where the nonmetal oxide is carbon dioxide (CO₂), the CO₂ may be introduced to the lime mud suspension as a component in a gas. The concentration of CO₂ in the gas used to neutralize the lime mud suspension may be from about 1 percent to about 100 percent by volume. In some embodiments, the concentration of CO₂ in the gas used to neutralize the lime mud suspension may be from about 5 percent to about 40 percent by volume.

The lime mud suspension may be mixed during addition of the nonmetal oxide to ensure efficient neutralization. The mixing can be done using any of a number of mixers, including, but not limited to, mechanical devices, such as a propeller blade mixer, Cowles type dispersion blade mixer, recirculation pump and the like, or future developed process equipment.

Next, the step 130 of separating large lime mud particles and/or grit particles from the lime mud suspension can be achieved through any of a variety of separation means including, but not limited to, screening, sedimentation, centrifugation, hydrocycloning or any combination thereof. In some embodiments, large lime mud particles and/or grit particles may be separated from the lime mud suspension by passing the suspension through a 60 mesh (250 micrometers mesh size) screen. Additionally or alternatively, one or more finer screen mesh sizes may be used alone or in combination. Examples of finer mesh screens that may be used include, but are not limited to, a 100 mesh (149 micrometers mesh size) screen, a 200 mesh (74 micrometers mesh size) screen, a 325 mesh (44 micrometers mesh size) screen or any combination thereof.

In alternative embodiments, the large lime mud particles and/or grit particles may be separated from the lime mud suspension prior to neutralizing the lime mud suspension with a nonmetal oxide. For example, the lime mud suspension is passed through a 60 mesh (250 micrometers) screen, and the resultant screened lime mud suspension is then neutralized through the addition of CO₂ gas to the lime mud suspension. In further alternative embodiments, the step of milling may be performed prior to dewatering and washing the neutralized and screened lime mud suspension.

The step 140 of dewatering the lime mud suspension can be achieved through any of a variety of dewatering means including, but not limited to, filtration, pressing, centrifugation, evaporation or any combination thereof. In some embodiments, the lime mud suspension is centrifuged to generate dewatered lime mud solids “centrifuge paste” having a solids content of about 30 percent by weight or greater. In other embodiments, the lime mud suspension is dewatered in a plate-and-frame press to generate dewatered lime mud solids “press cake” having a solids content of about 50 percent by weight or greater.

The step 150 of washing the dewatered lime mud solids is carried out in order to effectively remove water-soluble salts that may be present in the lime mud as produced in the causticization step of the kraft pulping process and/or water-soluble salts that are generated in the neutralization step such as, but not limited to, sodium bicarbonate (NaHCO₃). In some embodiments, the dewatered lime mud solids can be washed by passing water through the dewatered lime mud solids in the same device used to dewater the lime mud suspension. In other embodiments, a plurality of washing steps may be used to effectively remove water-soluble salts that are present in the dewatered lime mud solids.

In alternative embodiments, the dewatered lime mud solids may be re-suspended in water as part of the washing step and then dewatered to produce dewatered lime mud solids in which water-soluble salts have been effectively removed. In other embodiments, a plurality of dewatering/re-suspending in water/dewatering steps may be used to effectively remove water-soluble salts that are present in the lime mud. The amount of water-soluble salts being removed in any given washing step can be determined by measuring the specific conductivity of the wash water. The number of washing steps required to effectively remove water-soluble salts can then be determined relative to a desired specific conductivity.

The step 160 of milling the washed lime mud solids can be achieved using any suitable process equipment including, but not limited to, media mills, sand mills and the like, or future developed process equipment. In some embodiments, milling may be carried out by introducing the washed lime mud solids into a media mill containing grinding media such as glass, steel, sand, ceramic media including, but not limited to, aluminum oxide, zirconium oxide, zirconium silicate and the like or other suitable media, of a size from about 0.2 millimeters to about 5.0 millimeters.

In some embodiments, the washed lime mud solids are milled to produce a final PCC material comprising PCC particles having a particle size distribution d₅₀ value of about 4.0 micrometers or less. In other embodiments, the washed lime mud solids are milled to produce a final PCC material comprising PCC particles having a particle size distribution d₅₀ value of about 2.0 micrometers or less. In further embodiments, the washed lime mud solids are milled to produce a final PCC material comprising PCC particles having a particle size distribution d₅₀ value of from about 0.3 micrometers to about 4.0 micrometers. As used herein, the term “particle size distribution d₅₀ value” is defined as the numerical value, usually expressed in micrometers, at which 50 percent of the mass or volume fraction of particles have particle sizes that are less than or equal to that value.

In some embodiments, the washed lime mud solids can be diluted with water to provide a washed lime mud suspension having sufficient fluidity so as to be milled without a dispersant. In alternative embodiments, a dispersant may be added to the washed lime mud solids in an amount to provide sufficient fluidity to the washed lime mud solids so as to be milled as concentrated solids. The dispersant may be selected from those providing suitable dispersion of calcium carbonate. Non-limiting examples of dispersants include polycarboxylates, polyphosphates, polysulfonates and the like. In some embodiments, the dispersant is a sodium polyacrylate.

In some embodiments, the dispersant may be added to the washed lime solids before the milling process step. In other embodiments, the dispersant may be added during the milling process step to maintain sufficient fluidity to the washed lime mud solids during milling.

As used herein, the term “sufficient fluidity” is defined as a characteristic of the washed lime mud solids and/or suspension such that the washed lime mud solids and/or suspension is pumpable and flowable. In some embodiments, a washed lime mud solids and/or suspension having a viscosity of about 1000 centipoise (as measured by a Brookfield Viscometer using a spindle speed of 100 rpm) or lower has sufficient fluidity for the milling process step.

In some embodiments, the process for producing PCC from lime mud generated in the kraft pulping process may include a bleaching step to further improve the brightness of the PCC produced from lime mud. Any of a number of bleaching agents may be used to further improve the brightness of PCC from lime mud, including, but not limited to, sodium hypochlorite, hydrogen peroxide, sodium perborate, formamidine sulfinic acid (FAS) and the like. The bleaching agent may be added at various points during the process for making PCC from lime mud including, but not limited to, adding the bleaching agent after separating large lime mud particles and/or grit particles from the lime mud suspension, adding the bleaching agent before, during or after milling or any combinations thereof.

In some embodiments, the amount of bleaching agent used is from about 0.01 percent to about 1.0 percent by weight, based on the dry weight of the lime mud. In other embodiments, the amount of bleaching agent used is from about 0.05 percent to about 0.5 percent by weight, based on the dry weight of the lime mud.

The PCC produced from lime mud described herein is particularly useful as a filler for paper and paperboard products. In some embodiments, the PCC produced from lime mud may be used as the single filler for paper and paperboard. In alternative embodiments, the PCC produced from lime mud may be blended with other paper and paperboard fillers including, but not limited to, satellite PCC produced on-site at a paper mill, hereinafter referred to as “satellite PCC”, ground limestone, titanium dioxide (TiO₂), or any combination thereof.

In some embodiments, the PCC produced from lime mud may be blended with satellite PCC in a blend ratio of from about 1 part to about 99 parts PCC produced from lime mud, with the balance of the blend being satellite PCC, with the resultant blend being used as a filler for paper and paperboard. In other embodiments, the PCC produced from lime mud may be blended with satellite PCC in a blend ratio of from about 33 parts to about 67 parts PCC produced from lime mud, with the balance of the blend being satellite PCC, with the resultant blend being used as a filler for paper and paperboard. In further embodiments, the PCC produced from lime mud may be blended with satellite PCC in a blend ratio of about 50 parts PCC produced from lime mud to about 50 parts satellite PCC, with the resultant blend being used as a filler for paper and paperboard.

The PCC produced from lime mud described herein is particularly useful as a coating pigment for paper and paperboard products. In some embodiments, the PCC produced from lime mud may be used as the single coating pigment for paper and paperboard. In alternative embodiments, the PCC produced from lime mud may be blended with other coating pigments for paper and paperboard including, but not limited to, satellite PCC, ground limestone, coating grade clay, or any combination thereof.

In some embodiments, the PCC produced from lime mud may be blended with satellite PCC in a blend ratio of from about 1 part to about 99 parts PCC produced from lime mud, with the balance of the blend being satellite PCC, with the resultant blend being used as a coating pigment for paper and paperboard. In other embodiments, the PCC produced from lime mud may be blended with satellite PCC in a blend ratio of from about 33 parts to about 67 parts PCC produced from lime mud, with the balance of the blend being satellite PCC, with the resultant blend being used as a coating pigment for paper and paperboard. In further embodiments, the PCC produced from lime mud may be blended with satellite PCC in a blend ratio of about 50 parts PCC produced from lime mud to about 50 parts satellite PCC, with the resultant blend being used as a coating pigment for paper and paperboard.

In some embodiments, the washed lime mud solids may be blended with satellite PCC in a blend ratio of from about 1 part to about 99 parts lime mud suspension, with the balance of the blend being satellite PCC, with the resultant blend being milled to produce a final PCC material having a particle size distribution d₅₀ value of about 2.0 micrometers or less. In other embodiments, the washed lime mud solids may be blended with satellite PCC in a blend ratio of from about 33 parts to about 67 parts lime mud suspension, with the balance of the blend being satellite PCC, with the resultant blend being milled to produce a final PCC material having a particle size distribution d₅₀ value of about 2.0 micrometers or less. In further embodiments, the washed lime mud solids/satellite PCC blend may be milled to produce final PCC material having a particle size distribution d₅₀ value of from about 0.3 micrometers to about 2.0 micrometers. In some embodiments, a dispersant may be added to the washed lime mud solids/satellite PCC blend prior to and/or during milling and in an amount to provide sufficient fluidity to the blend during milling. The pigment produced from milling the washed lime mud solids/satellite PCC blend may be used as a coating pigment for paper and paperboard.

The PCC produced from lime mud described herein may alternatively be used for a variety of other PCC applications, and is not limited to paper or paperboard products. Other uses for the PCC produced from lime mud described herein may include, but are not limited to, use as an additive for paints and polymers such as, but not limited to, plastics, sealants and the like.

### EXAMPLES

The following non-limiting examples are merely illustrative embodiments of the present teachings and are not to be construed as limiting the invention.

In the examples described below, particle size distribution values were determined based on sedimentation techniques using a Micromeritics Sedigraph model 5100 instrument (Micromeritics Instrument Corporation, Norcross, Ga.). In the examples described below, the term “specific surface area” is defined as the Brunauer-Emmett-Teller (BET) specific surface area (SSA) of the PCC particles contained in a dry powder sample of PCC, as measured on a Micromeritics FlowSorb II single point surface area instrument (Micromeritics Instrument Corporation, Norcross, Ga.).

### Example 1

A lime mud suspension having a solids concentration of about 45 percent by weight was screened using a 60 mesh screen to remove large lime mud particles and grit. The screened lime mud suspension was then treated with gaseous CO₂ having a concentration of 20 percent CO₂ by volume in order to lower the pH from about 13 to about 9. Approximately 700 milliliters of the resulting neutralized lime mud suspension was then milled using a laboratory scale media mill (Chicago Boiler Co., Gurnee, Ill.) containing about 2600 grams of about 0.8 to 1.0 millimeters in diameter zirconium silicate media. The lime mud suspension was milled for about 30 minutes in order to reduce the particle size distribution d₅₀ value to about 0.9 micrometers and a specific surface area (SSA) of about 7.9 meters² per gram. The lime mud suspension was then filtered in a Buchner vacuum funnel to generate a cake having a solids content of about 70 percent by weight. This cake was washed with water and then filtered in a Buchner vacuum funnel to generate a cake having a solids content of about 70 percent by weight. This cake was then dispersed using sodium polyacrylate (Acumer® 9300, available from Rohm & Haas, Philadelphia, Pa.) at a dispersant level of about 0.4 percent dry weight of dispersant per dry weight of lime mud suspension using a Cowles type dispersion blade mixer at 5000 rpm to produce a final PCC from lime mud suspension having a viscosity of about 525 centipoise measured by a Brookfield Viscometer at a spindle speed of 100 rpm.

### Example 2

Handsheets having a target basis weight of 75 grams per meter² were prepared using a Formax (Noble and Wood) sheet former. The pulp furnish consisted of 75 percent bleached hardwood and 25 percent bleached softwood kraft pulps refined to 400 and 450 Canadian Standard Freeness (CSF), respectively. A cationic potato starch (Stalok® 400, available from Tate & Lyle, Decatur, Ill.) was used at a level of 0.75 percent (15 pounds of starch per ton of paper). An alkyl ketene dimer (AKD) synthetic sizing agent (Hercon® 115, available from Hercules Inc., Wilmington, Del.) was used at a level of 0.25 percent (5 pounds of AKD per ton of paper). A high molecular weight anionic polyacrylamide (PAM) retention aid (Nalco® 625, available from Nalco Chemical Co., Naperville, Ill.) was used at a level of 0.01 percent (0.2 pounds of PAM per ton of paper). The fillers were added to the pulp furnish to achieve target filler loading levels of about 10 percent and about 20 percent. After the handsheets were formed on the Formax sheet former, they were double-pressed between stainless steel rolls at 25 pounds per inch. In the first pressing the sheet was still on the Formax forming wire, sandwiched between pieces of papermachine “wet felt” material. The sheet was then removed from the forming wire, sandwiched between two pieces of unsized blotting paper, and pressed again. The handsheets were then dried on a drum dryer at 115 degrees Celsius. The handsheets were conditioned and tested under TAPPI (Technical Association of the Pulp and Paper Industry) standard conditions of 23 degrees Celsius and 50 percent relative humidity.

The fillers evaluated in this handsheet study included a PCC produced from lime mud according to one embodiment of the present invention having a particle size distribution d₅₀ value of 1.07 micrometers and a specific surface area (SSA) of 9.5 meters² per gram and a satellite PCC (ALBACAR® LO precipitated calcium carbonate, available from Specialty Minerals, Inc., Bethlehem, Pa.) having a particle size distribution d₅₀ value of 1.95 micrometers and a specific surface area (SSA) of 5.2 meters² per gram. Blends of these two fillers were also evaluated in this handsheet study, one blend containing 67 percent by weight of the PCC produced from lime mud and 33 percent by weight of the satellite PCC and the other blend containing 33 percent by weight of the PCC produced from lime mud and 67 percent by weight of the satellite PCC. Handsheets containing no filler (i.e. unfilled handsheets) were also prepared and tested as a control.

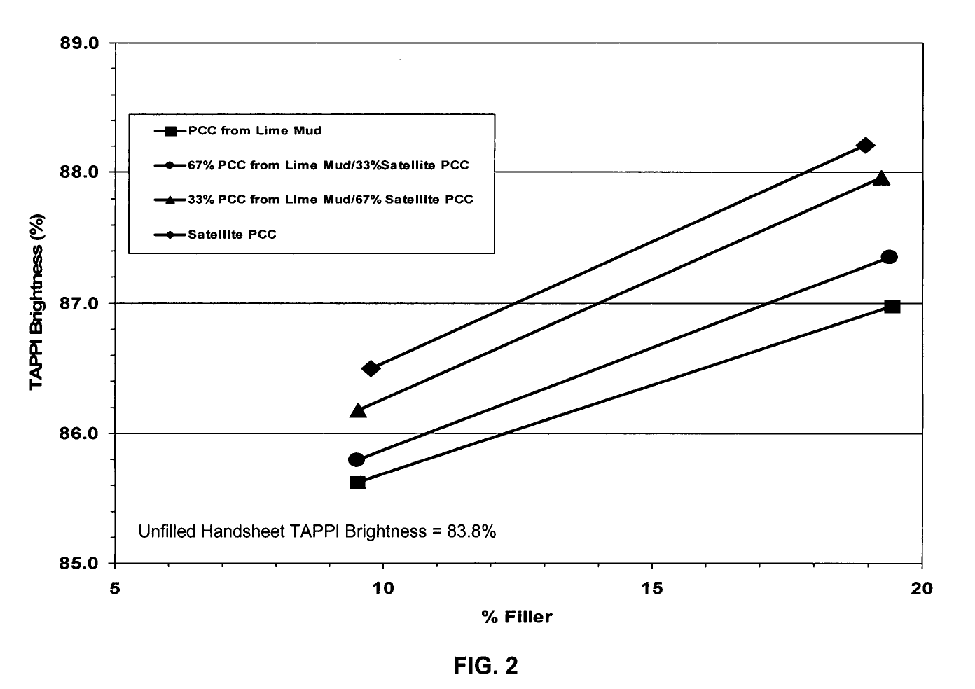

FIG. 2 shows a graph of TAPPI Brightness (measured in accordance with TAPPI Test Method T 452 om-98) versus percent filler for the various fillers and filler blends evaluated in this handsheet study. The results show that PCC produced from lime mud can be used as a filler in paper to improve paper brightness compared to the unfilled control and this paper brightness improvement increases with increasing filler level. The results also show that lime mud PCC can be blended with satellite PCC to further enhance the brightness improvements in paper.

### Example 3

Three coating formulations were evaluated in this study. The coating formulation hereinafter referred to as Coating Formulation 1 contained a blend of 50 parts satellite PCC (OPACARB® A40 precipitated calcium carbonate, available from Specialty Minerals Inc., Bethlehem, Pa.) and 50 parts high brightness No. 1 clay (Hydragloss® 90, available from J.M. Huber Corp., Atlanta, Ga.). The coating formulation hereinafter referred to as Coating Formulation 2 contained 50 parts ground limestone (Hydrocarb® 90, available from Omya Inc., Proctor, Vt.) and 50 parts high brightness No. 1 clay (Hydragloss® 90, available from J.M. Huber Corp., Atlanta, Ga.). The coating formulation hereinafter referred to as Coating Formulation 3 contained a blend of 16.5 parts PCC from lime mud, 33.5 parts satellite PCC (OPACARB® A40 precipitated calcium carbonate, available from Specialty Minerals Inc., Bethlehem, Pa.) and 50 parts high brightness No. 1 clay (Hydragloss® 90, available from J.M. Huber Corp., Atlanta, Ga.). A latex/starch binder system was used in all coating formulations. The latex (Dow XU 30929.50, available from Dow Chemical Co., Midland, Mich.) was used at a level of 9 parts. The starch (Penford® Gum 280, available from Penford Products, Inc., Cedar Rapids, Iowa) was used at a level of 4 parts. One part of a calcium stearate lubricant (Devflo™ 50C, available from Devden Inc., Bromont, QC) was also used in all formulations. Coatings having a target coat weight of 9 pounds per 3300 ft² were prepared using a cylindrical laboratory coater (CLC-6000, SimuTech Inc., Hoodsport, Wash.) operating at 2500 feet per minute. The coated sheets were calendered using a 2 nip press at 500 pounds per inch², 150 degrees Fahrenheit prior to testing.

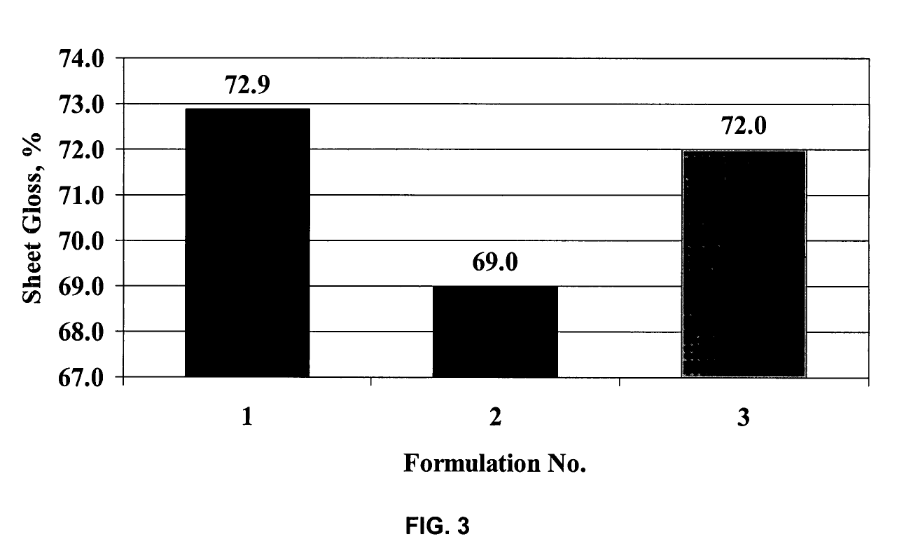

FIG. 3 shows a graph of Sheet Gloss measured at a specular angle of 75 degrees in accordance with TAPPI test method T 480 om-92 using a Technidyne Glossmeter Model T480 (Technidyne Corp., New Albany, Ind.) for Coating Formulations 1, 2 and 3. The results show that PCC produced from lime mud can be used in a coating formulation for paper to achieve good sheet gloss.

While embodiments and applications have been shown and described, it will be apparent to those skilled in the art that modifications are possible without departing from the inventive concepts herein described. It is understood, therefore, that the invention is capable of modification and therefore is not to be limited to the precise details set forth. Rather, various modifications may be made in the details within the scope and range of equivalents of the claims without departing from the spirit of the invention.

What is claimed is:

1. A process for producing precipitated calcium carbonate (PCC) from lime mud generated in the kraft pulping process comprising:
providing an aqueous suspension of lime mud;
neutralizing the lime mud suspension with a nonmetal oxide;
separating large lime mud particles and/or grit particles from the lime mud suspension;
dewatering the lime mud suspension to produce dewatered lime mud solids;
washing the dewatered lime mud solids to produce washed lime mud solids; and
milling the washed lime mud solids to produce a final PCC material.

2. The process according to claim 1, wherein the nonmetal oxide is selected from the group consisting of carbon dioxide, sulfur dioxide, sulfur trioxide and mixtures thereof.

3. The process according to claim 1, wherein the nonmetal oxide is carbon dioxide provided as a component in a gas.

4. The process according to claim 3, wherein the concentration of carbon dioxide in the gas is from about 1 percent to about 100 percent by volume.

5. The process according to claim 3, wherein the concentration of carbon dioxide in the gas is from about 5 percent to about 40 percent by volume.

6. The process according to claim 1, wherein the nonmetal oxide is added to the lime mud suspension in an amount sufficient to produce a lime mud suspension pH of about 9.5 or less.

7. The process according to claim 1, wherein the separating step is performed by passing the lime mud suspension through at least one screen.

8. The process according to claim 7, wherein the at least one screen has a mesh size of 60 mesh (250 micrometers mesh size) or finer.

9. The process according to claim 1, wherein the separating step is performed by sedimentation.

10. The process according to claim 1, wherein the separating step is performed by centrifugation.

11. The process according to claim 1, wherein the separating step is performed by the use of a hydrocyclone.

12. The process according to claim 1, wherein the separating step is performed prior to the neutralizing step.

13. The process according to claim 1, wherein the dewatering step is performed by one or more of filtration, pressing, centrifugation and evaporation to produce dewatered lime mud solids having a lime mud solids content of about 30 percent by weight or greater.

14. The process according to claim 1, wherein the washing step is performed by passing water through the dewatered lime mud solids to produce washed lime mud solids.

15. The process according to claim 1, wherein the washing step is performed by re-suspending of the dewatered lime mud solids in water to produce re-suspended lime mud solids, followed by dewatering of the re-suspended lime mud solids to produce washed lime mud solids.

16. The process according to claim 15, wherein the washing step is repeated.

17. The process according to claim 1, wherein the milling step is performed to produce a final PCC material comprising PCC particles having a particle size distribution d₅₀ value of about 4.0 micrometers or less.

18. The process according to claim 1, wherein a dispersant is added to the washed lime mud solids prior to the milling step, the dispersant being selected from the group consisting of polycarboxylates, polyphosphates, polysulfonates, and sodium polyacrylate and mixtures thereof.

19. The process according to claim 1, wherein a dispersant is added to the washed lime mud solids during the milling step, the dispersant being selected from the group consisting of polycarboxylates, polyphosphates, polysulfonates, and sodium polyacrylate and mixtures thereof.

20. The process according to claim 1, wherein the washed lime mud solids are blended with a satellite PCC material prior to the milling step.

21. The process according to claim 20, wherein the milling step is performed to produce a final PCC material comprising PCC particles having a particle size distribution d₅₀ value of about 2.0 micrometers or less.

22. The process according to claim 1, further comprising a step of bleaching one of the group consisting of the lime mud suspension, the dewatered lime mud solids, the washed lime mud solids and the final PCC material, the bleaching being performed after the separating step.

23. The process according to claim 22, wherein the bleaching step is performed using a bleaching agent selected from the group consisting of sodium hypochlorite, hydrogen peroxide, sodium perborate and formamidine sulfinic acid (FAS).
